(19) United States
(12) Patent Application Publication
(10) Pub. No.: US 2002/0174890 A1
(43) Pub. Date: Nov. 28, 2002

(54) Fluid circulating system

(75) Inventors: Sam Chou, Taipei (TW); Derek Ju, Pingjen City (TW); Andy Chiu, Taoyuan (TW)

Correspondence Address: LOWE HAUPTMAN GILMAN & BERNER, LLP, Suite 310, 1700 Diagonal Road, Alexandria, VA, 22314, US

(73) Assignee: HannStar Display Corp.

(21) Appl. No.: 10/072,933

(22) Filed: Feb. 12, 2002

(30) Foreign Application Priority Data
May 23, 2001 (TW) 90112727

(51) Int. Cl. G05D 11/08

(52) U.S. Cl. 137/4

(57) ABSTRACT

A fluid circulating system for providing a fluid into a manufacturing equipment and receiving a drained fluid from the manufacturing equipment. The system comprises: a tank for containing the fluid, wherein the tank has a filling conduit with an filling electromagnetic valve for conducting the fluid; a supplying conduit for conducting the fluid into the manufacturing equipment, wherein the supplying conduit comprises a circulating pump for driving the fluid; a draining conduit for conducting the fluid from the manufacturing equipment to the tank; an analyzer for measuring the quality of the fluid; an outlet conduit having an outlet electromagnetic valve and connected to the tank; and a controlling device for opening the outlet electromagnetic valve to drain out fluid in the tank and opening the filling electromagnetic valve for filling the tank when the data measured by the analyzer is lower than a first predetermined value and closing the outlet electromagnetic valve when the data measured by the analyzer is higher than a second predetermined value.

### BACKGROUND OF THE INVENTION

1. Field of the Invention

The present invention relates to a fluid circulating system, and more particularly to a fluid circulating system for supplying good quality circulating water to a heat exchanging apparatus, cooling apparatus, or a preheater and the like.

2. Description of the Related Art

The fluid circulating system is commonly used in the industry. It is an essential unit in the manufacturing process. For example, the air or liquid circulating is used to achieve the cooling or heating function in the heat exchanging apparatus by thermal conductance and thermal convection.

Currently, the treatment process arrangement of the circulating water for the heat exchanging apparatus is depended on the water quality of the resource. For example, a mechanical pre-filtering is used to remove particles and suspensions, a reverse osmosis equipment is used to remove inorganic ions, organic compounds and salt, an ion exchanging resin equipment is used to remove salt, and so on. A great part of the circulating water of the heat exchanging apparatus is treated by a cycling treatment and reused, and the maintenance of the cycling system is related to the factors polluting the circulating water, for example the impurities and the membrane of microorganism that block the cycling system and trace metals and calcium, magnesium salts that make limescale and corrosion. The water quality might be affected by at least one of the above-mentioned factors, therefore the maintenance of the cycling system is not an easy job.

Referring to FIGS. 1 and 2, a block diagram and a flow chart of the fluid circulating system 10 in the prior art are shown. In an embodiment, two sets of the same fluid circulating system 10 respectively provide 20° C. and 80° C. deionized water to a heat exchanging apparatus and/or a manufacturing equipment. Due to the high pureness demand of the circulating water, the resistivity of the water is mainly used as the key standard to control and monitor the quality of the circulating water. The fluid circulating system 10 comprises a tank 20 for storing the circulating water, a circulating pump 21 for pumping the circulating water into the manufacturing equipment, an inlet conduit 22 for conducting the circulating water into the manufacturing equipment, an inlet valve 23 for controlling the flow of the circulating water, and a draining conduit 28 for conducting the circulating water from the manufacturing equipment to the tank 20. The fluid circulating system further includes a filtering system which comprises a filter valve 25, a filter 26 and a draining valve 27.

When the resistivity of the circulating water is higher than 0.8 MΩ·cm, the circulating water flows into the manufacturing equipment by closing the filter valve 25 and opening the inlet valve 23, and then the water flows back to the tank 20 via the draining conduit 28. When the resistivity of the circulating water in the tank 20 is lower than 0.8 MΩ·cm, it shows the quality of the water is not acceptable, thus the circulating water passes the filter 26 first and flows back to the tank via the draining valve 27 and the draining conduit 28 by closing the inlet valve 23 and opening the filter valve 25.

After filtering, if the quality of the water is still not acceptable, it is needed to open an outlet valve 31 to drain out the water, and to open an inlet valve 30 for supplementing the circulating water. However, if the water drains out so fast that the water supplying rate is unable to compensate for the drained water, the manufacturing equipment should be stopped due to the low level of the water. After using the filter 26 for a long time, the quality of the circulating water will not be able to meet the predetermined value, thus the cartridge filters and other elements should be changed periodically to maintain the filtering and deionizing capacity of the filter. Nevertheless, stopping the filtering system is needed in the changing aids step, and it causes the circulating water to spill out easily. It will actuate an electric leakage sensor when the circulating water spills out, then the manufacturing equipment will be stopped.

Accordingly, a fluid circulating system for continuously providing the circulating fluid is needed. It is utilized to increase the throughput of the manufacturing equipment and to decrease the cost of the manufacturing process.

### SUMMARY OF THE INVENTION

It is a primary object of the present invention to provide an uninterrupted fluid circulating system for overcoming the disadvantage of the discontinuous operation of the circulating water.

It is another object of the present invention to provide a method for continuously providing the circulating fluid into a manufacturing equipment thereby decreasing the interrupting time of the manufacturing equipment and increasing the throughput rate and reduces the manufacturing cost.

To achieve the above listed objects, the present invention provides a fluid circulating system for providing a fluid into a manufacturing equipment and receiving a drained fluid from the manufacturing equipment. The system comprises: a tank for containing the fluid, wherein the tank has a filling conduit with a filling electromagnetic valve for conducting the fluid; a supplying conduit for conducting the fluid into the manufacturing equipment, wherein the supplying conduit comprises a circulating pump for driving the fluid; a draining conduit for conducting the drained fluid from the manufacturing equipment to the tank; an analyzer for measuring the quality of the fluid; an outlet conduit having an outlet electromagnetic valve and connected to the tank; and a controlling device for opening the outlet electromagnetic valve and draining out the fluid in the tank and opening the filling electromagnetic valve for filling the tank when the data measured by the analyzer is lower than a first predetermined value and closing the outlet electromagnetic valve when the data measured by the analyzer is higher than a second predetermined value.

According to another aspect of the fluid circulating system of the present invention, the manufacturing equipment is a heat exchanging apparatus.

According to another aspect of the fluid circulating system of the present invention, the fluid is deionized water.

Therefore, the fluid circulating system can provide the manufacturing equipment with the circulating fluid under uninterrupted operation and control the quality of the circulating fluid to satisfy the various needs of the manufacturing equipment.

Other objects, advantages, and features of the invention will become more apparent from the following detailed description and embodiment when taken in conjunction with the accompanying drawings, wherein the similar elements and steps are designated with corresponding reference numerals.

### BRIEF DESCRIPTION OF THE DRAWINGS

FIG. 1 is a block diagram of a conventional fluid circulating system;

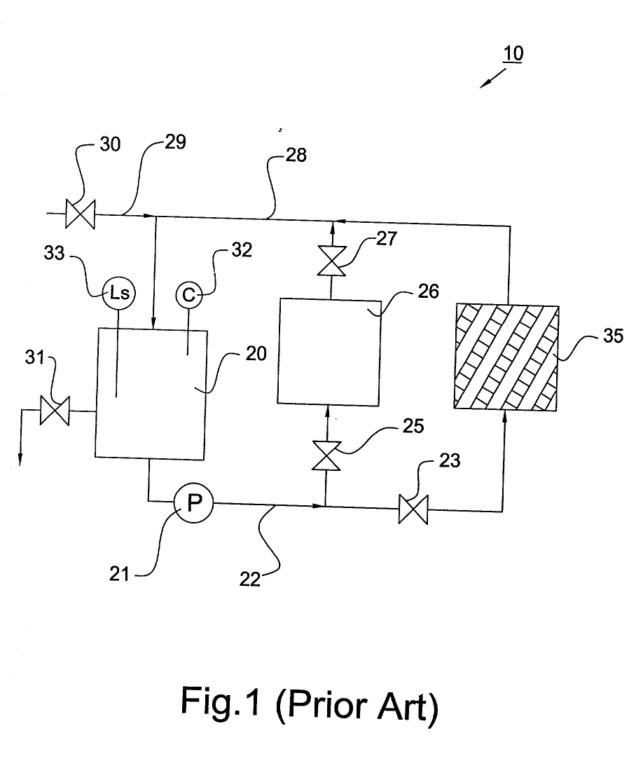

FIG. 2 is a flow chart of controlling steps taken by a conventional fluid circulating system;

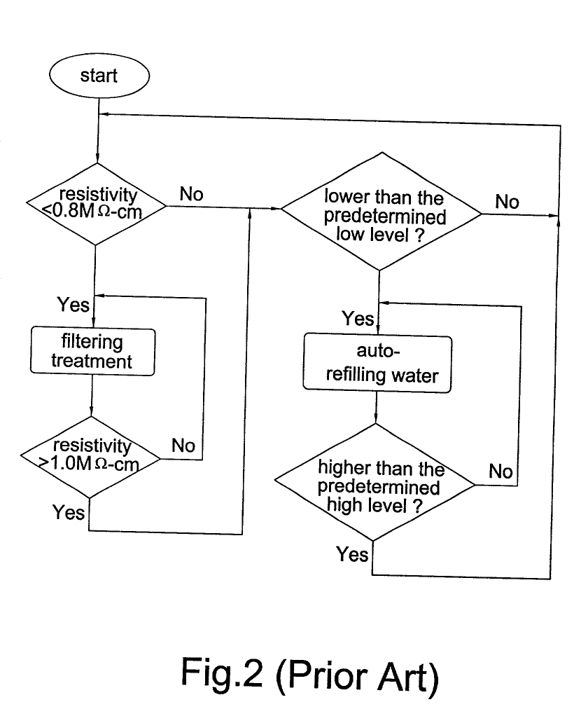

FIG. 3 is a block diagram of a preferred embodiment of a fluid circulating system of the present invention;

FIG. 4 is a flow chart of controlling steps taken by a fluid circulating system of a preferred embodiment of the present invention;

FIG. 5 is a chart of the relationship between the water resistivity in a hot water cycle of a first heat exchanging apparatus and time, wherein the fluid circulating system of the present invention is applied to the first heat exchanging apparatus;

FIG. 6 is a chart of the relationship between the water resistivity in a cold water cycle of the first heat exchanging apparatus and time, wherein the fluid circulating system of the present invention is applied to the first heat exchanging apparatus;

FIG. 7 is a chart of the relationship between the water resistivity in a hot water cycle of a second heat exchanging apparatus and time, wherein the fluid circulating system of the present invention is applied to the second heat exchanging apparatus; and

FIG. 8 is a chart of the relationship between the water resistivity in a cold water cycle of the second heat exchanging apparatus and time, wherein the fluid circulating system of the present invention is applied to the second heat exchanging apparatus.

### DETAILED DESCRIPTION OF THE PREFERRED EMBODIMENT

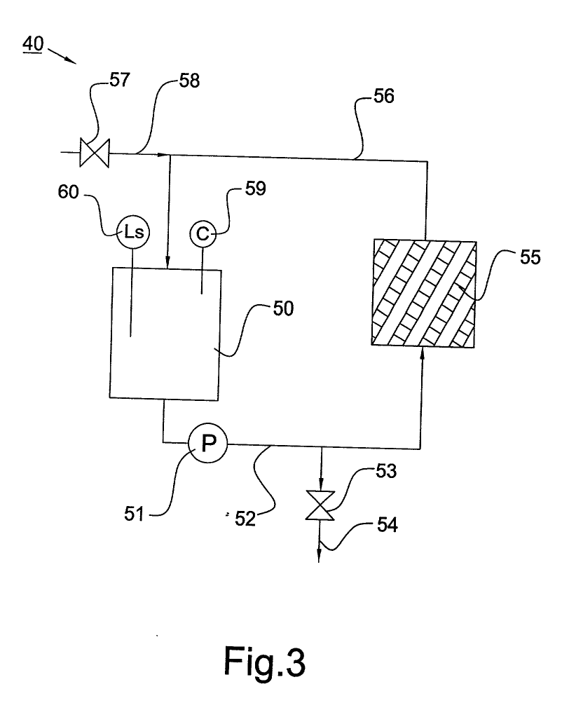

A fluid circulating of a heat exchanging apparatus will be taken as an embodiment to describe the present invention detailedly. It should be noted that the fluid circulating system of the present invention is not limited to the embodiment. According to the fluid circulating system of the present invention, it can be applied to other kinds of equipment easily. Referring to FIG. 3, it depicts the fluid circulating system 40 of the present invention. For example, for use in a heat exchanging apparatus and/or a manufacturing equipment 55, the system 40 comprises a tank 50, a circulating pump 51, a supplying conduit 52, an electromagnetic valve 53, a draining conduit 56, a resistivity-meter 59 and a water level sensor 60 for controlling the circulating water quality of the heat exchanging apparatus 55. The circulating water is pumped into the heat exchanging apparatus 55 by the circulating pump 51 from the tank 50, and then the water flows back to the tank 50 via the draining conduit 56 to form a close circulating water cycle.

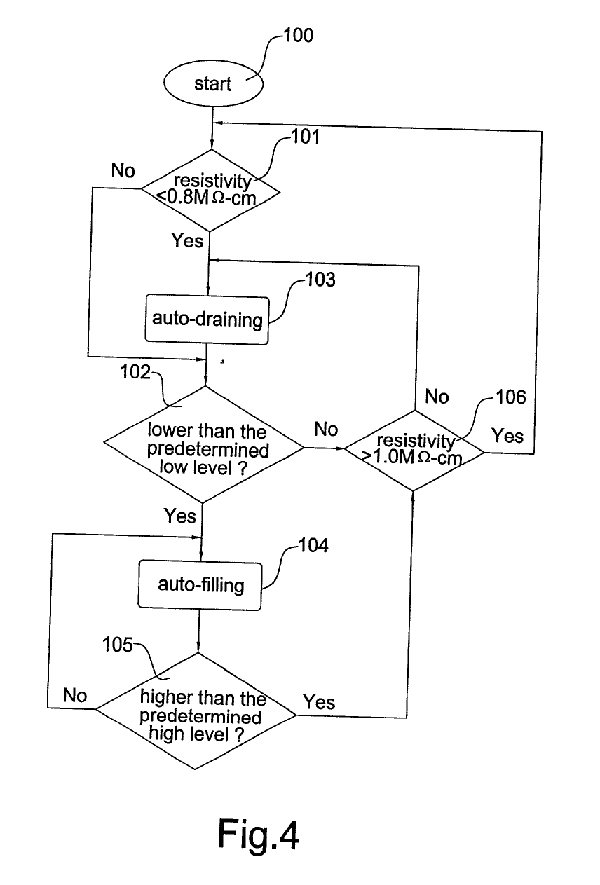

Referring to FIG. 4, a process of controlling the water quality by the fluid circulating system 40 is shown. The water quality controlling process starts from step 100 to step 101. In step 101, it is checked whether the resistivity of the circulating water in the tank 50 is lower than 0.8 MΩ·cm or not by the system 40. If the resistivity is lower than 0.8 MΩ·cm then the process goes to step 103; if not, the process goes to step 102. In step 103, a draining valve 53 would be opened by the system 40 to drain out the circulating water via a draining conduit 54, and then the process goes to step 102.

In step 102, it is checked whether the water level in the tank 50 is lower than a predetermined low level or not. If the Water level is lower than the predetermined low level, the process goes to step 104; if not, the process goes to step 106. In step 104, a filling valve 57 connected to a circulating water source, is open by the system 40 for supplementing new circulating water, and then the process goes to step 105. In step 105, it is checked whether the water level is higher than a predetermined high level or not. If the water level is higher than the predetermined high level, the process goes to step 106; if not, the process goes to step 104. In step 106, it is checked whether the resistivity of the circulating water in the tank 50 is higher than 1.0 MΩ·cm or not. If the resistivity of the circulating water is higher than 1.0 MΩ·cm, the process goes to step 101; if not, the process goes to step 103.

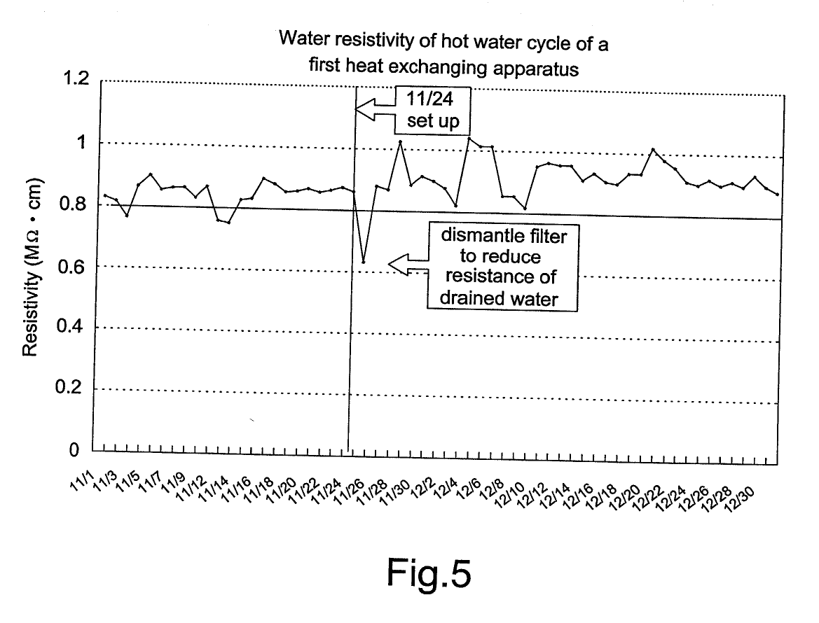

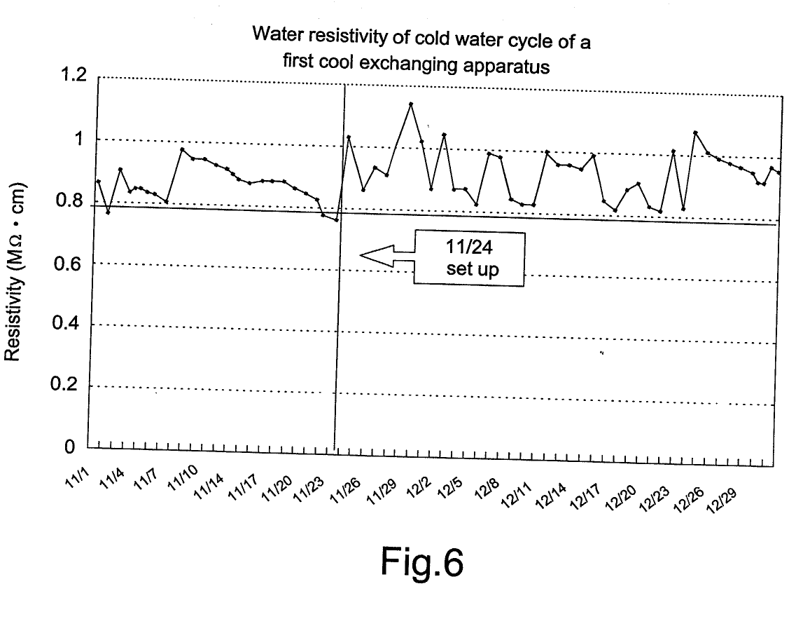

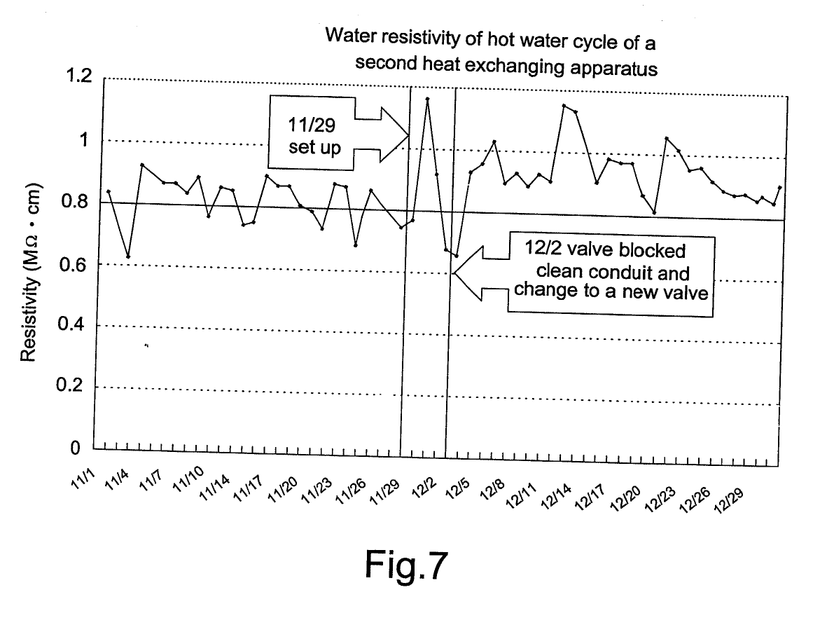

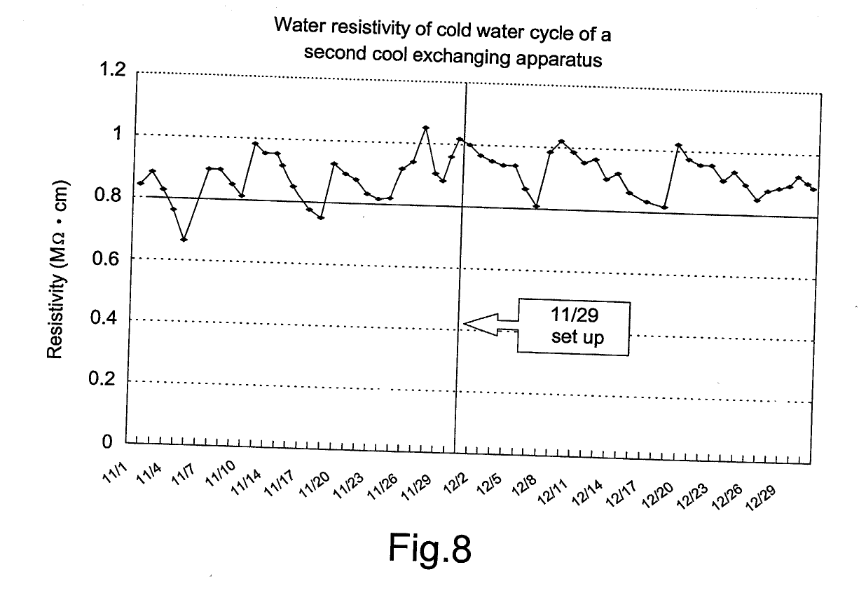

Referring to FIGS. 5-8, they illustrate the measured result of the water quality of the fluid circulating system of the present invention applying to the AKT-3500 heat exchanging apparatus manufactured by Applied Komatsu Technology (Takatsukadai Nishi-Ku Kove-Shi, Hyogo, Japan), wherein the fluid circulating system is used for providing a 20° C. cold water cycle and an 80° C. hot water cycle respectively. FIG. 5 illustrates the relationship between the water resistivity in a hot water cycle of a first heat exchanging apparatus and time, wherein the fluid circulating system of the present invention is applied to the first heat exchanging apparatus. FIG. 6 illustrates the relationship between the water resistivity in a cold water cycle of the first heat exchanging apparatus and time, wherein the fluid circulating system of the present invention is applied to the first heat exchanging apparatus. FIG. 7 illustrates the relationship between the water resistivity in a hot water cycle of a second heat exchanging apparatus and time, wherein the fluid circulating system of the present invention is applied to the second heat exchanging apparatus. FIG. 8 illustrates the relationship between the water resistivity in a cold water cycle of the second heat exchanging apparatus and time, wherein the fluid circulating system of the present invention is applied to the second heat exchanging apparatus.

As shown in the figures, the water quality of the fluid circulating system is substantially better than the water quality in the prior art. The resistivity of the system is not lower than 0.8 MΩ·cm, i.e., the circulating water quality of the heat exchanging apparatus is maintained above the, standard value. Furthermore, the present invention provides a continuously operating circulating system. Compared to the prior art, it decreases the interrupting time of the equipment and thereby reduces the cost of manufacturing.

Although the preferred embodiments of the invention have been disclosed for illustrative purposes, those skilled in the art will appreciate that various modifications, additions and substitutions are possible, without departing from the scope and spirit of the invention as set forth in the appended claims.

What is claimed is:

1. A fluid circulating system for providing a fluid into a manufacturing equipment and receiving a drained fluid from the manufacturing equipment, the system comprising:
a tank for containing the fluid having a filling conduit with a filling electromagnetic valve for conducting the fluid;
a supplying conduit for conducting the fluid into the manufacturing equipment having a circulating pump for driving the fluid;
a draining conduit for conducting the drained fluid from the manufacturing equipment to the tank;
an analyzer for measuring the quality data of the fluid;
an outlet conduit connected to the tank having an outlet electromagnetic valve; and
a controlling device for opening the outlet electromagnetic valve to drain out the fluid in the tank and opening the filling electromagnetic valve for filling the tank when the data measured by the analyzer is lower than a first predetermined value and closing the outlet electromagnetic valve when the data measured by the analyzer is higher than a second predetermined value.

2. The fluid circulating system as claimed in claim 1, wherein the manufacturing equipment is a heat exchanging apparatus.

3. The fluid circulating system as claimed in claim 1, wherein the fluid is deionized water.

4. The fluid circulating system as claimed in claim 1, wherein the analyzer is a resistivity-meter.

5. The fluid circulating system as claimed in claim 4, wherein the first predetermined value is about 0.8MΩ·cm.

6. The fluid circulating system as claimed in claim 4, wherein the second predetermined value is about 1.0MΩ·cm.

7. The fluid circulating system as claimed in claim 1, wherein the tank further has a fluid level sensor for automatically opening or closing the filling electromagnetic valve when the level of the fluid in the tank is not within a predetermined range.

8. A fluid circulating system controlling method for controlling the quality of a circulating fluid of a fluid circulating system, wherein the fluid circulating system provides a fluid to a manufacturing equipment and receives a drained fluid from the manufacturing equipment, the method comprising steps of:
providing a tank for containing the fluid, wherein the tank has a filling conduit with an filling electromagnetic valve for conducting the fluid;
providing a supplying conduit for conducting the fluid into the manufacturing equipment, wherein the supplying conduit comprises a circulating pump for driving the fluid;
providing a draining conduit for conducting the fluid from the manufacturing equipment to the tank;
providing an analyzer for measuring the quality data of the fluid;
providing an outlet conduit connected to the tank having an outlet electromagnetic valve:
opening the outlet electromagnetic valve for draining out the fluid in the tank when the data measured by the analyzer is lower than a first predetermined value; and
closing the outlet electromagnetic valve when the data measured by the analyzer is higher than a second predetermined value.

9. The fluid circulating system controlling method as claimed in claim 8, wherein the manufacturing equipment is a heat exchanging apparatus.

10. The fluid circulating system controlling method as claimed in claim 8, wherein the fluid is deionized water.

11. The fluid circulating system controlling method as claimed in claim 8, wherein the analyzer is a resistivity-meter.

12. The fluid circulating system controlling method as claimed in claim 11, wherein the first predetermined value is about 0.8MΩ·cm.

13. The fluid circulating system controlling method as claimed in claim 11, wherein the second predetermined value is about 1.0MΩ·cm.

14. The fluid circulating system controlling method as claimed in claim 8, wherein the tank further has a fluid level sensor, and the method further comprises a step of:
automatically opening or closing the filling electromagnetic valve when the level of the fluid in the tank is not within a predetermined range.
